(19) United States
(12) Patent Application Publication
(10) Pub. No.: US 2026/0218556 A1
(43) Pub. Date: Jul. 30, 2026

(54) MOVABLE PANEL SYSTEM

(71) Applicant: METALGLAS BONOMI S.R.L., Lumezzane (Brescia) (IT)

(72) Inventor: Giordano BONOMI, Lumezzane (Brescia) (IT)

(21) Appl. No.: 19/146,375

(22) PCT Filed: Feb. 14, 2024
(86) PCT No.: PCT/IB2024/051369

§ 371 Date: Jul. 8, 2025

(30) Foreign Application Priority Data
Apr. 14, 2023 (IT) 102023000007185

(51) Int. Cl. E05D 15/58; E05D 15/06

(52) U.S. Cl. CPC E05D 15/58; E05D 15/0665; E05Y 2201/612; E05Y 2201/64; E05Y 2201/684; E05Y 2900/132

(57) ABSTRACT

A movable panel system has a lower guide having a pair of rails mutually parallel and transversely spaced, each rail having a shank and a head, at least one panel slidingly supported on the lower guide, having a lower edge, and sliding and rotation elements having a carriage group and a base. The carriage group has a support body, at least one pair of wheels, each slidingly engageable with a respective rail, and a retaining and lifting device engaged with the support body and adapted to be positioned at least partially in a space between the pair of rails. The panel is configurable in a sliding configuration, in which the wheels slidingly engage the rails, and an end configuration, in which the retaining and lifting device engages the base so that at least one wheel is disengaged from the respective rail allowing movement about a vertical axis of the panel.

The subject of the present invention is a movable panel system.

In the prior art, there are known solutions for movable panel systems that, according to requirements, make it possible to close off an environment, for example a veranda.

In particular, movable panel systems are known which are configurable in a closing configuration, in which the panels are arranged longitudinally and separate the two adjacent environments, and a packaged configuration, in which the panels are rotated and mutually adjacent, in such a way as to connect the two environments.

In the known embodiments, the panels are typically made of glass and are large in size, allowing for natural lighting of the environment, even with the panels in the closed position.

Within the sector, movable panel systems are known wherein said panels are engaged to an upper guide which is in turn attached to a ceiling or a beam whereupon, therefore, the full force of the weight of the panels is entirely born.

A typical problem with the known solutions is related to the size of the panels, which are becoming increasingly large both longitudinally and vertically: the increase in panel size corresponds to an increase in the criticality of design, production, and operation of support and movement systems.

Additional problems typical of the known solutions are related to the size of the components suitable for moving the panels: panels of increasing size are matched with components that are in turn large in size and bulk, thus resulting in clutter and obstruction.

Additionally, for some types of installations, for example for outdoor use, the characteristics of the building or the load-bearing structure do not permit the installation of known movable panel systems. In fact, large panels cause structural problems with pergolas, ceilings and/or upper beams.

The object of the present invention is to present a movable panel system that meets the aforementioned needs and overcomes the aforementioned disadvantages.

This object is achieved by the movable panel system claimed in claim 1. The claims dependent on these request protection for further features and entail further technical benefits.

Further features and advantages of the invention will be made readily apparent from the following description of preferred embodiment examples thereof, provided purely by way of non-limiting example, with reference to the accompanying figures, in which:

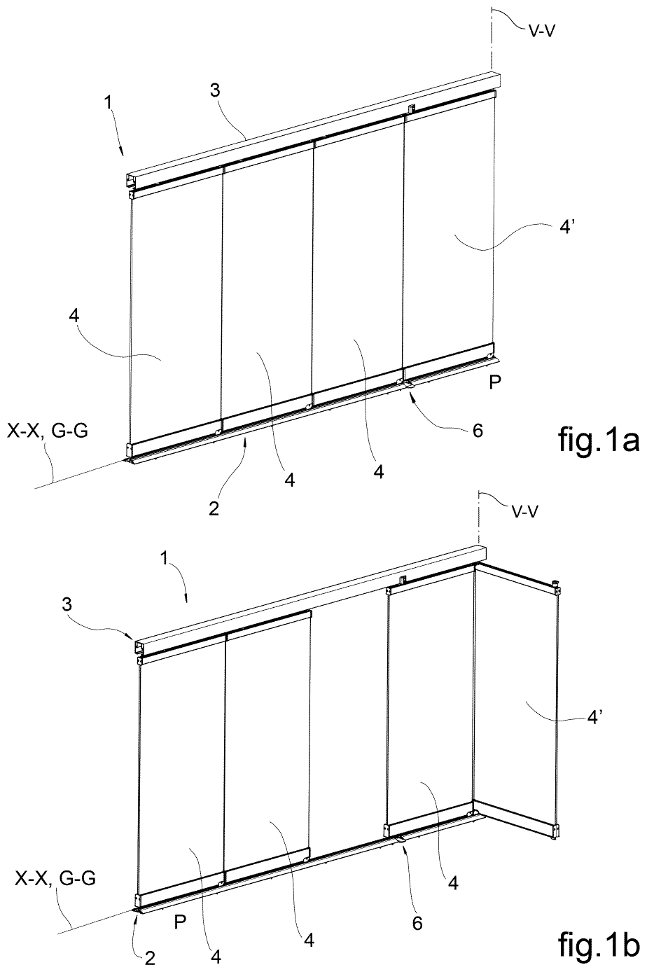

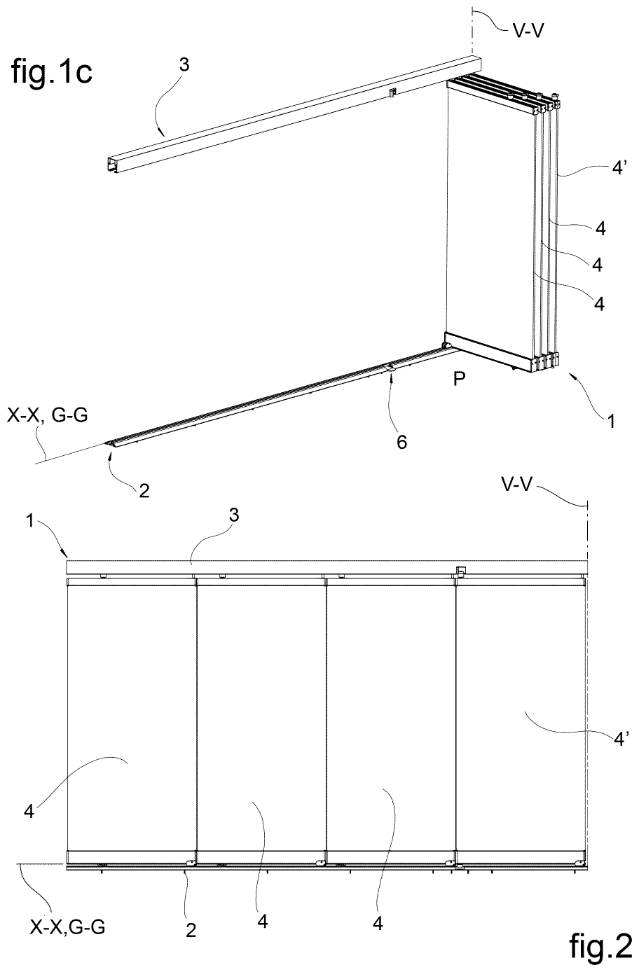

FIGS. 1a, 1b and 1c are a perspective view of the movable panel system according to the present invention, in a preferred embodiment in a closing configuration, in an intermediate opening configuration, and in an opening configuration with the panels packaged, respectively;

FIG. 2 is a side view of the movable panel system in FIG. 1a;

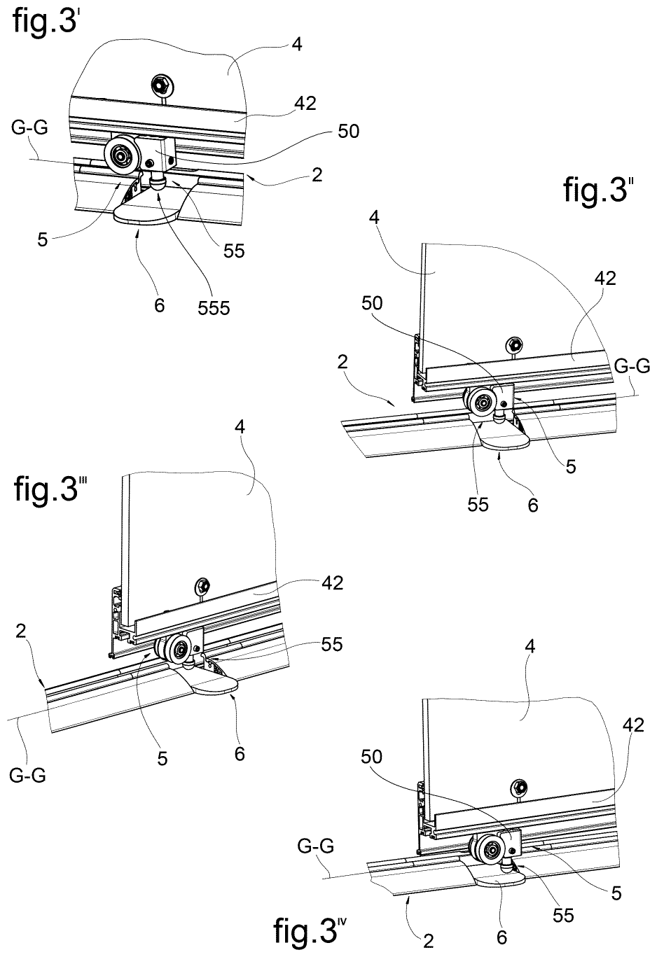

FIGS. 3′, 3″, 3′″ and 3^{IV} are some perspective views of a carriage group of the movable panel system in a sliding configuration, an end configuration, and a rotated configuration, respectively;

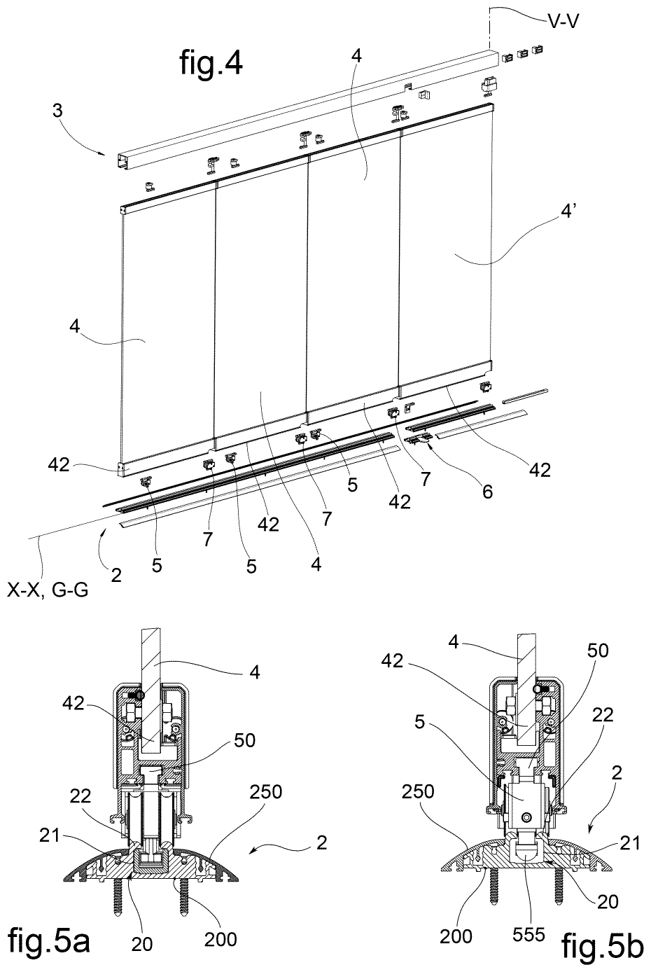

FIG. 4 is a perspective view of the movable panel system according to the present invention, in a preferred embodiment;

FIGS. 5a and 5b are two cross-sectional views of the carriage group in FIGS. 3′ and 3″, 3′″ and 3^{IV} sliding in a lower guide;

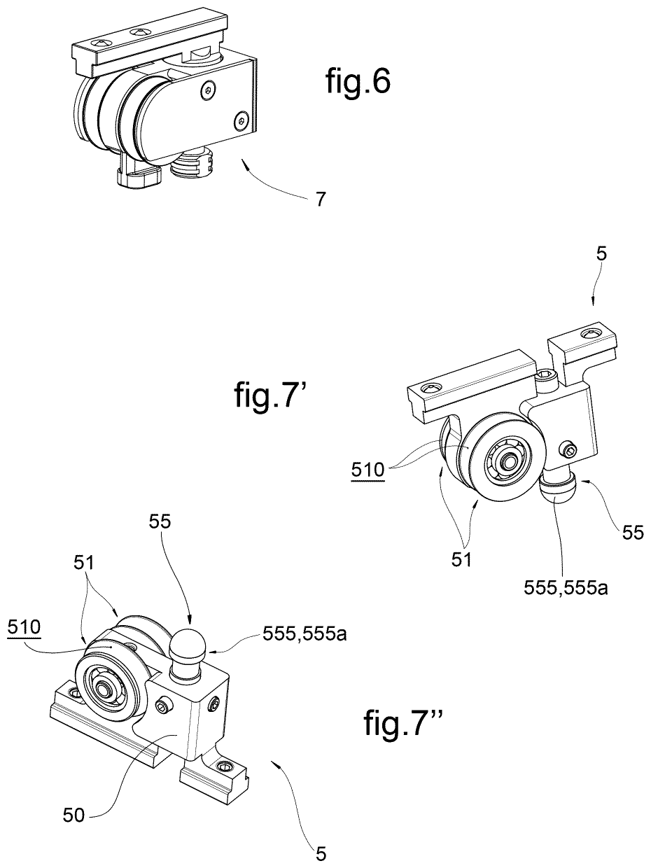

FIG. 6 is a perspective view of a load-bearing carriage group comprised in the movable panel system according to the present invention;

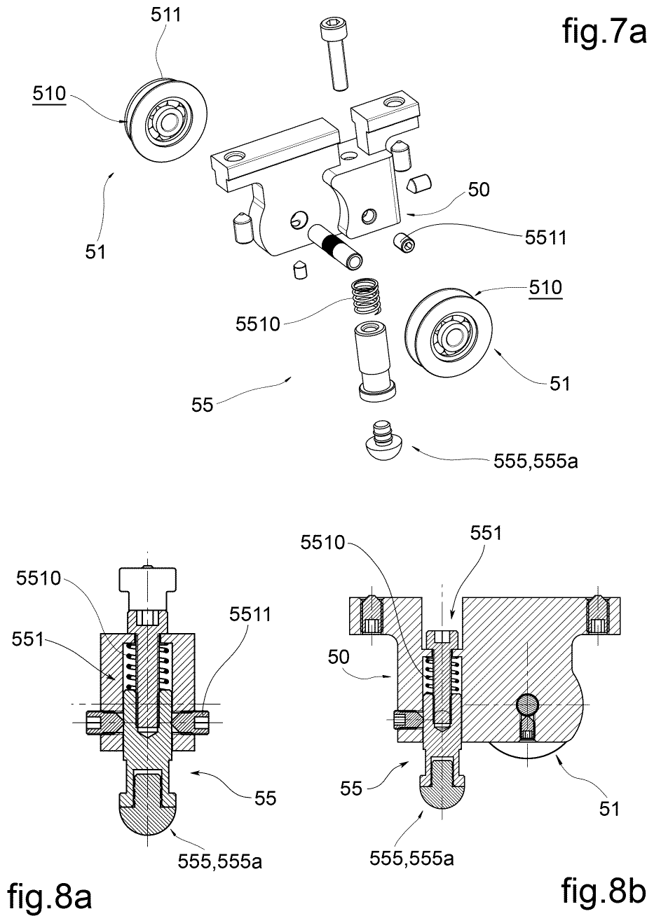

FIGS. 7′ and 7″ are two perspective views of a carriage group comprised in the movable panel system according to the present invention, in a first preferred embodiment;

FIG. 7a is a perspective view in separate parts of the carriage group in FIGS. 7′ and 7″;

FIGS. 8a and 8b are a cross-sectional view and a longitudinal sectional view of the carriage group in FIGS. 7′ and 7″;

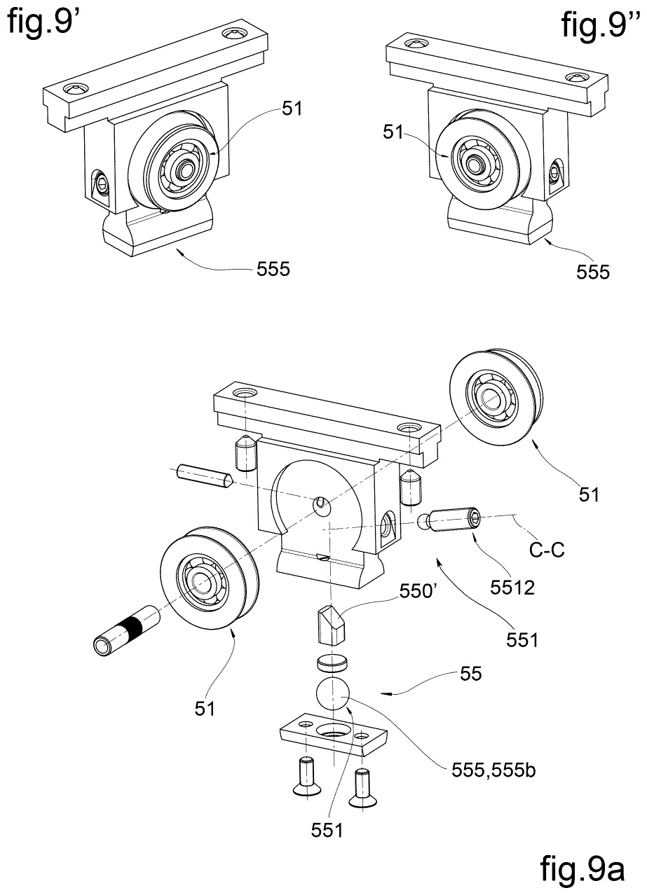

FIGS. 9′ and 9″ are two perspective views of a carriage group comprised in the movable panel system according to the present invention, in a second preferred embodiment;

FIG. 9a is a perspective view in separate parts of the carriage group in FIGS. 9′ and 9″;

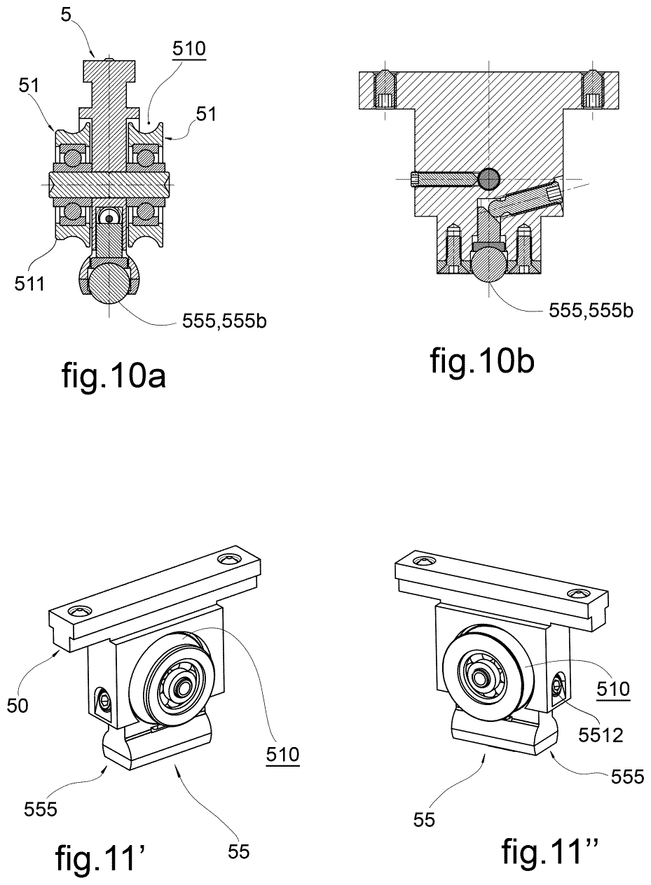

FIGS. 10a and 10b are a cross-sectional view and a longitudinal sectional view of the carriage group in FIGS. 9′ and 9″;

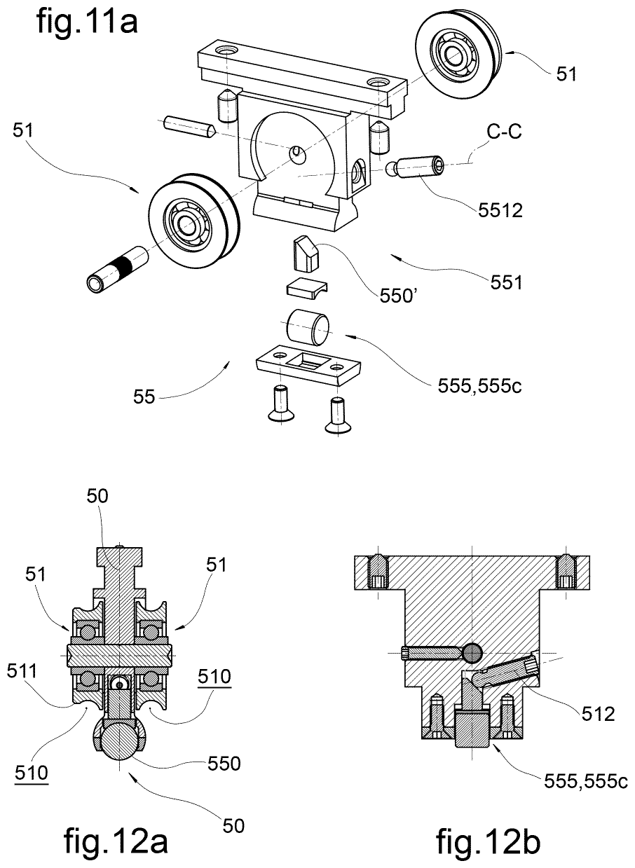

FIGS. 11′ and 11″ are two perspective views of a carriage group comprised in the movable panel system according to the present invention, in a third preferred embodiment;

FIG. 11a is a perspective view in separate parts of the carriage group in FIGS. 11′ and 11″;

FIGS. 12a and 12b are a cross-sectional view and a longitudinal sectional view of the carriage group in FIGS. 11′ and 11″;

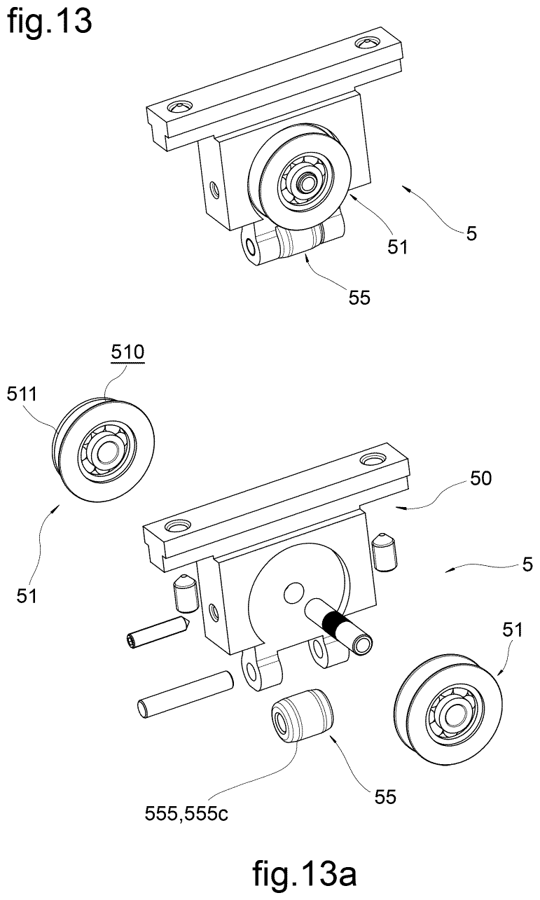

FIG. 13 is a perspective view of a carriage group comprised in the movable panel system according to the present invention, in a fourth preferred embodiment;

FIG. 13a is a perspective view in separate parts of the carriage group in FIG. 13;

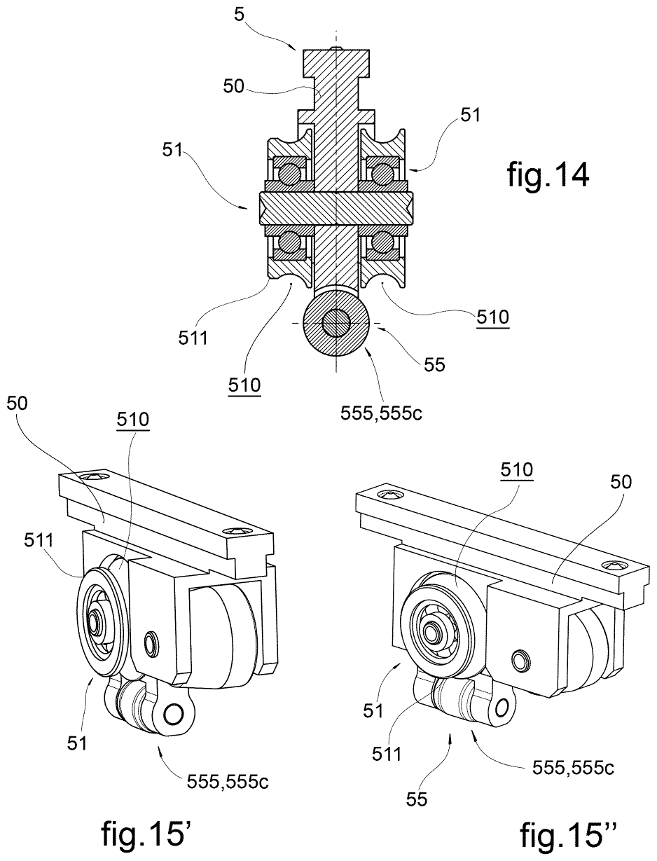

FIG. 14 is a cross-sectional of the carriage group in FIG. 13;

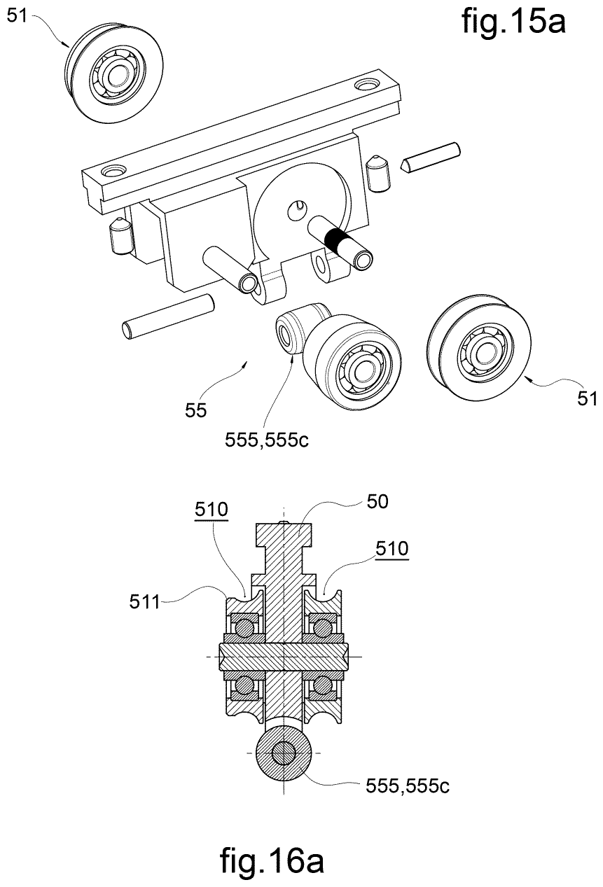

FIGS. 15′ and 15″ are two perspective views of a carriage group comprised in the movable panel system according to the present invention, in a fifth preferred embodiment;

FIG. 15a is a perspective view in separate parts of the carriage group in FIGS. 15′ and 15″;

FIG. 16a is a cross-sectional view of the carriage group in FIGS. 15′ and 15″;

FIG. 17 is a perspective view of the lower guide and base of the movable panel system according to the present invention;

FIG. 17a is a perspective view in separate parts of the lower guide and base in FIG. 17;

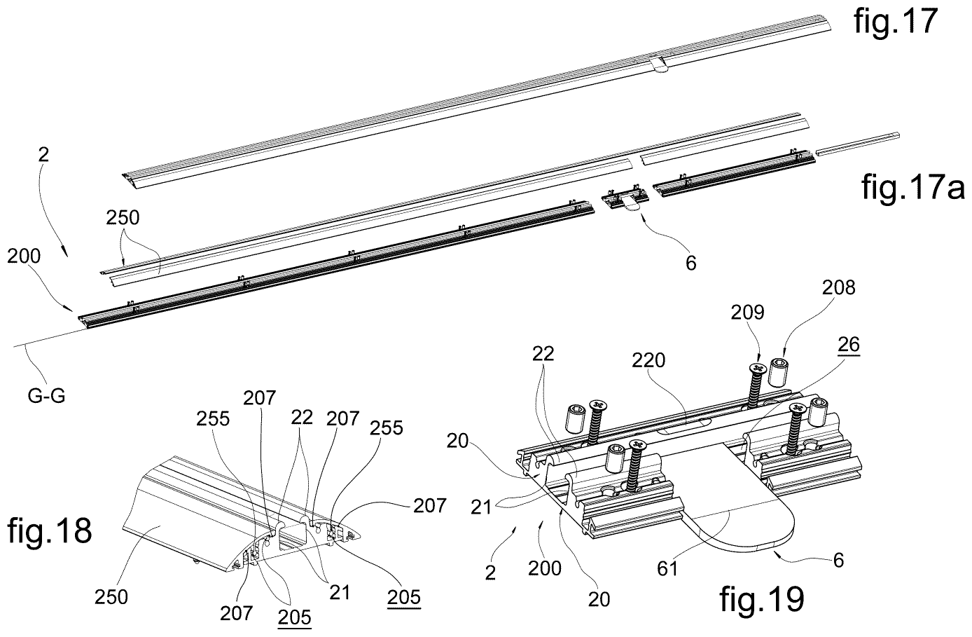

FIG. 18 is a perspective view of a portion of the lower guide and base in FIG. 17;

FIG. 19 is a perspective view in separate parts of a portion the lower guide and base in FIG. 17.

With reference to the accompanying figures, a movable panel system according to the present invention is indicated in the entirety thereof with the numeral 1.

According to the present invention, the movable panel system 1 comprises a lower guide 2 suitable for resting on a ground plane P.

According to a preferred embodiment, the movable panel system 1 also comprises an upper guide 3 vertically spaced apart from the lower guide 2.

According to the present invention, the lower guide 2 extends along a guide axis G-G.

According to a preferred embodiment, the movable panel system 1 extends mainly along a longitudinal axis X-X, for example parallel to a ground plane P.

According to a preferred embodiment, the guide axis G-G is parallel to the longitudinal axis X-X.

According to a different preferred embodiment, the guide axis G-G is curvilinear and/or straight in sections and extends mainly along the longitudinal axis X-X.

According to the present invention, the lower guide comprises a pair of rails 20, mutually parallel and transversely spaced.

Each rail 20 comprises a shank 21 and a head 22 protruding transversely from said shank 21.

Preferably, the head 22 has a convex shape.

Preferably each rail 20 therefore is T- or L-shaped.

According to a preferred embodiment, between the two rails 20, in particular between the two shanks 21 and below the two heads 22 a space is delimited, specifically functional for the anti-lifting of the respective panel as described in detail hereinafter.

According to a preferred embodiment, the lower guide 2 comprises a guide body 200 positionable on the ground plane P. Said rails 20 are comprised in said guide body 200.

Preferably, the lower guide 2 comprises a pair of covering profiles 250 each suitable for covering a guide body portion 200 from a respective rail 20. Said covering profiles 250 are suitable for leaving the heads 22 and the space between two rails 20 freely accessible.

According to a preferred embodiment, said covering profiles 250 extend transversely inclined, preferably arched.

Preferably the covering profiles 250 are suitable for allowing easy passage over the guide body 200.

According to a preferred embodiment, the guide body 200 comprises a pair of blocking slots 205 extending parallel along the guide axis G-G. Preferably, each covering profile 250 comprises a blocking tooth 255 suitable for snap-engaging said blocking slot 205.

According to a preferred embodiment, the guide body 200 comprises attachment means 209 suitable for attaching the guide body 200 to the ground plane P.

According to a preferred embodiment, the guide body 200 comprises vertically positionable positioning means 208 to set the height of the guide body 200.

Preferably, the attachment means 209 comprise screw elements, passing through the guide body 200 to be screwed into the ground plane P.

Preferably, the positioning means 208 comprise spacer elements, such as dowels, screwed to the guide body 200 to position them at a height and then adjust the height of the guide body 200 on the ground plane P.

Preferably, said positioning means 208 directly engage the ground plane P.

Preferably, said positioning means 208 engage a plate-shaped element extending along the guide axis G-G positioned between the guide body 200 and the ground plane P.

According to a preferred embodiment, both the attachment means 209 and the positioning means 208 are placed below the covering profiles 250. In other words, both the attachment means 209 and the positioning means 208 are operable before the installation of the covering profiles 250. In still other words, with covering profiles 250 installed, neither the attachment means 209 nor the positioning means 208 are accessible.

According to a preferred embodiment, the guide body 200 comprises protruding support projections 207, spaced apart from the rails 20, which extend parallel to the guide axis G-G in which the covering profiles 250 rest on said protruding support projections 207.

Preferably, said protruding support projections 207 are sized to support the covering profiles 250. Preferably, an action of the weight force on the covering profiles 250 is discharged on said protruding support projections 207.

Preferably, for each side, the guide body 200 comprises a plurality of protruding support projections 207.

According to a preferred embodiment, the guide body 200 consists of a single component, or the alignment of several distinct components, obtained by means of extrusion operations.

According to a preferred embodiment, the guide body 200 is a plastic component.

According to a preferred embodiment, the covering profiles 250 are made of a metal material, such as aluminum alloy.

According to a preferred embodiment, the covering profiles 250 have a shape that is substantially complementary to the guide body portion 200 that they cover: for example, an arched guide body portion 200 is covered by an arched covering profile 250; for example, an inclined guide body portion 200, for example triangular, is covered by an inclined covering profile 250.

According to the present invention, the movable panel system comprises at least one panel 4 of planar shape, preferably made of glass, slidingly supported on the lower guide 2. The panel 4 comprises a lower edge 42.

Preferably, the panel 4 further comprises an upper edge engaged, for example partially housed, within a sliding seat of the upper guide 3.

According to the present invention, the movable panel system 1 comprises sliding and rotation means. The sliding and rotation means allow the panel 4 to slide along the guide axis G-G of the panel 4 and allow the panel 4 to rotate with respect to a vertical axis. In other words, the rotation means make it possible for the movable panel system to be configured in a closing configuration wherein said closing configuration corresponds to a packaged configuration.

Said sliding and rotation means comprise a base 6 attached to the lower guide 2. The features of said base 6 are described extensively hereinafter.

Said sliding and rotation means comprise a carriage group 5 engaged to the panel 4 at the bottom, particularly at the lower edge 42.

The carriage group 5 comprises a solid support body 50, preferably made as one piece.

According to a different embodiment, the support body is directly attached to the panel 4, preferably attached to the lower edge 42, by coupling means, for example transverse screws.

According to the present invention, the carriage group 5 comprises at least one pair of wheels 51 hinged to the support body 50, each slidingly engageable with a respective rail 20.

According to a preferred embodiment, the carriage group 5 comprises a plurality of pairs of wheels 51.

Preferably, the wheels 51 are mutually spaced transversely on both sides of the support body 50. Preferably the support body 50 comprises a specific housing for each wheel 51.

According to a preferred embodiment, each wheel 51 comprises a concave profile comprising a concave surface 510 intended to be in slidable contact with the head 22.

According to the present invention, the carriage group 5 also comprises a retaining and lifting device 55 engaged to the support body 50.

According to the present invention, the panel 4 is configurable along the guide axis G-G in a sliding configuration and in an end configuration. In the sliding configuration, the wheels 51 slidingly engage the rails 20 and the panel 4 is movable along the guide axis G-G. In the end configuration, the retaining and lifting device 55 engages the base 6 in such a way that at least one wheel 51, preferably both, is disengaged from the respective rail 20, and the panel 4 is movable about a vertical axis V-V.

According to a preferred embodiment, in the end configuration, the panel 4 is in proximity of a longitudinal end of the lower guide 2, for example in proximity of a side wall or an upright of the movable panel system.

According to a preferred embodiment, in the end configuration, the panel 4 is at a predefined longitudinal position along the lower guide 2, for example at a position distal from a side wall or an upright of the movable panel system.

According to a preferred embodiment, the base 6 is engaged to the rail 20.

According to a preferred embodiment, the base 6 comprises an inclined surface 61 extending transversely from the guide axis G-G, engageable by the retaining and lifting device 55 in the movement of the panel 4 about the vertical axis V-V.

Preferably, the retaining and lifting device 55 is thus suitable for engaging the base 6 to allow a proper alignment of the wheels 51 with the rails 20 and a smooth rotation of the panel 4.

According to a preferred embodiment, in which the lower guide 2 comprises a rotation window 26 in which the base 6 is positioned, wherein said rotation window 26 transversely interrupts a rail 20.

According to a preferred embodiment, transversely at the rotation window 26, a rail 20 comprises a flattened head region 220.

Preferably, the wheel 51 sliding on the rail 20 with the flattened head region 220 comprises a rounded wheel edge 511. Preferably, at the flattened head region 220, due in part to the presence of the rounded wheel edge 511 the rotation of the panel 4 is facilitated.

In a preferred embodiment, the base 6 is a solid body, preferably made as one piece.

According to a preferred embodiment, the base 6 has a planar shape, having a first dimension along the guide axis G-G and a second dimension in the transverse direction the rail 20. Preferably, the base 6 has a reduced vertical dimension compared to the other two dimensions.

According to a preferred embodiment, the base 6 has a predominant dimension along a transverse direction relative to the guide axis G-G.

According to the present invention, the retaining and lifting device 55 is adapted to be positioned at least partially in the space between the two rails 20 underneath the respective heads 22.

In other words, as mentioned, in addition to fulfilling the object of engaging the base 6 to facilitate the rotation operations, the retaining and lifting device 55 fulfills the object of acting as an anti-lifting element by engaging the lower guide 2. Any lifting is, in fact, prevented due to the partial housing of the retaining and lifting device 55 in the space between the two rails 20. In other words, any lifting is in fact prevented by the engagement between the retaining and lifting device 55 and the head 22 of the rails 20.

According to a preferred embodiment, the retaining and lifting device 55 comprises a retaining and lifting member 550 that protrudes from the support body 50 extending vertically and transversely. Preferably, said retaining and lifting member 550 is specially adapted to engage the base 6 and accommodate the rail heads 22 in the space below. Preferably, said retaining and lifting member 550 protrudes transversely until it is vertically facing the concave surface 510 of the two wheels 51.

Preferably, the retaining and lifting device 55 comprises adjustment members 551 housed in the support body 50 operable to adjust the vertical position of the retaining and lifting member 550.

According to a preferred embodiment, the adjustment members 551 comprise an elastic element 5510 which pushes the retaining and lifting member 550, and blocking elements 5511 operable between an unblocking position, in which the retaining and lifting member 500 is vertically movable, and a blocking position, in which the retaining and lifting member 500 is vertically fixed.

According to a further embodiment, the adjustment members 551 comprise an adjustment pin 5512 engaged at one end of the retaining and lifting member 550, preferably comprising an inclined plane 550′, wherein the adjustment pin 5512 is positionable to be adjusted along a control axis C-C, wherein a position of the adjustment pin 5512 corresponds to a vertical position of the retaining and lifting member 550.

According to a preferred embodiment, the retaining and lifting member 550 comprises a rounded portion 555 adapted to slide on the base 6.

Preferably, said rounded portion 555 comprises a sliding half-sphere 555a or a sliding ball 555b or a sliding roller 555c.

Preferably, said rounded portion 555 is housed between two rails 20 below the two respective heads 22.

According to a preferred embodiment, the sliding and rotation means also comprise a load-bearing carriage group 7 engaged with the lower edge 42, for example spaced longitudinally from the carriage group 5. Preferably, the load-bearing carriage group 7 comprises an element adapted to support axial loads and at the same time adapted to support the panel 4 on the lower guide 2 when rotating and sliding, for example, an anti-friction flanged bushing.

According to a preferred embodiment, in the end configuration of the panel 4, the panel 4 is positionable in a plurality of angular positions, in which the rotational solid of the retaining and lifting device 55 is disengaged from the base 6 and the panel 4 is supported to be cantilevered on the lower guide 2 by means of the load-bearing carriage group 7.

That is to say that, with the rotational solid of the retaining and lifting device 55 disengaged from the base 6, the weight force of the panel 4 is discharged onto the load-bearing carriage group 7.

According to a preferred embodiment, the movable panel system 1 comprises a plurality of panels 4, each comprising a lower edge and preferably also an upper edge.

According to a preferred embodiment, the movable panel system 1 comprises a, vertically rotatable, end panel 4′ adapted to maintain its axial position along the guide 2.

According to a preferred embodiment, the sliding and rotation means comprise a single base 6.

According to a preferred embodiment, each respective panel 4 comprises a respective carriage group 5 suitable for engaging said base 6 in the end configuration according to that which has been described above. In other words, each carriage group 5 of each panel 4 is arranged at a longitudinal position of the panel 4 in which it is engageable with the base 6.

Preferably, the sliding and rotation means comprise a load-bearing carriage group 7 for each panel 4 that is suitable for supporting the respective panel 4 to be cantilevered on the lower guide 2.

Regarding the operation of the movable panel system, in the sliding configuration, the panel 4 is slidingly moved along the lower guide 2. Continuing along the guide axis G-G, the sliding device 55 of the carriage group 5 engages the base 6 in order to configure the panel 4 in the end configuration.

Innovatively, the movable panel system fully fulfills the intended object in overcoming the typical problems of the prior art.

Advantageously, the movable panel system does not structurally burden ceilings and/or beams and/or lintels. Advantageously, the force of the weight of the panels is discharged onto the lower guide, obviating the problem of installations that engage ceilings and/or beams and/or lintels.

Advantageously, it is also possible to mount the movable panel system in outdoor installations that are typically lacking in structural load-bearing capacity. Advantageously, the upper guide does not have a panel support function, i.e. it does not support any weight. Advantageously, the upper guide is structurally simple and inexpensive to implement.

Advantageously, the ceiling and/or beam and/or lintel is free to flex, for example as a result of the action of snow accumulation or other structural elements, without affecting the sliding of the panels. Advantageously, the load generated by the panels bears upon the ground plane and is efficiently stabilized during rotation.

Advantageously, the panels are configurable between the sliding configuration and the end configuration in an extremely simple and intuitive way, obviating the need to have additional devices or to carry out additional movements. Advantageously, in fact, the transition between one configuration and another is by means of continuously sliding the panel along the guide axis.

Advantageously, the base facilitates panel movements in both longitudinal and rotational directions.

Advantageously, the retaining and lifting device is suitable for facilitating the rotation of the panels while also holding them to the lower guide in sliding operations.

Advantageously, the retaining and lifting device is height-adjustable so as to allow any design errors to be recuperated.

Advantageously, each panel is adjustable separately from the other panels.

Advantageously, the sliding and rotation of the panel is done in an extremely simple, intuitive and smooth manner.

Advantageously, the carriage group is easy to install and simple to construct.

It is clear that a person skilled in the art may make changes to the invention described above in order to meet contingent needs, which changes all fall within the scope of protection as defined in the following claims.

1. A movable panel system comprising:
i) a lower guide extending along a guide axis, suitable for resting on a ground plane, comprising a pair of rails, mutually parallel and transversely spaced, wherein each rail of the pair of rails comprises a shank and a head protruding transversally from the shank;
ii) at least one panel slidingly supported on the lower guide and comprising a lower edge; and
iii) sliding and rotation means comprising:
a carriage group, engaged with the lower edge, comprising:
a support body;
at least one pair of wheels hinged to the support body, each wheel of the at least one pair of wheels being slidingly engageable with a respective rail of the pair of rails;
a retaining and lifting device engaged with the support body and adapted to be positioned at least partially in a space between the pair of rails underneath the respective heads; and
a base fixed to the lower guide and extending transversely to the guide axis;
wherein the at least one panel is configurable along the guide axis in:
a sliding configuration, in which the wheels slidingly engage the rails; and
an end configuration, in which the retaining and lifting device engages the base so that at least one wheel of the at least one pair of wheels is disengaged from the respective rail allowing a movement about a vertical axis of the at least one panel.

2. The movable panel system of claim 1, wherein the base comprises an inclined surface extending transversely from the guide axis, engageable by the retaining and lifting device moving the at least one panel about the vertical axis.

3. The movable panel system claim 1, wherein the lower guide further comprises a rotation window in which the base is positioned, and wherein the rotation window transversely interrupts one rail of the pair of rails.

4. The movable panel system of claim 3, wherein, transversely at the rotation window, one rail of the pair of rails comprises a flattened head region.

5. The movable panel system of claim 1, wherein the wheels comprise a concave surface in which the head of the respective rail is housed.

6. The movable panel system of claim 4, wherein the wheels comprise a concave surface in which the head of the respective rail is housed, and wherein the wheel of the at least one pair of wheels sliding on the rail with the flattened head region comprises a rounded wheel edge.

7. The movable panel system of claim 1, wherein the retaining and lifting device comprises a retaining and lifting member protruding from the support body by extending vertically and transversely.

8. The movable panel system of claim 7, wherein the retaining and lifting device further comprises adjustment members housed in the support body and operable to adjust a vertical position of the retaining and lifting member.

9. The movable panel system of claim 8, wherein the adjustment members comprise an elastic element which pushes the retaining and lifting member and blocking elements operable between an unblocking position, in which the retaining and lifting member is vertically movable, and a blocking position, in which the retaining and lifting member is vertically fixed.

10. The movable panel system of claim 8, wherein the adjustment members comprise an adjustment pin engaged at one end of the retaining and lifting member, wherein the adjustment pin is positionable along a control axis, and wherein a position of the adjustment pin corresponds to the vertical position of the retaining and lifting member.

11. The movable panel system of claim 8, wherein the retaining and lifting member comprises a rounded portion adapted to slide on the base.

12. The movable panel system of claim 11, wherein the rounded portion comprises one of a sliding half-sphere, a sliding ball, or a sliding roller.

13. The movable panel system of claim 1, wherein the sliding and rotation means further comprise a load-bearing carriage group engaged with the lower edge, wherein the load-bearing carriage group comprises an element adapted to support axial loads and the at least one panel when rotating and sliding on the lower guide.

14. The movable panel system of claim 13, wherein, in the end configuration, the at least one panel is rotatable to a plurality of angular positions in which the retaining and lifting device is disengaged from the base and the at least one panel is supported to be cantilevered on the lower guide by the load-bearing carriage group.

15. The movable panel system of claim 1, comprising a plurality of panels, wherein the sliding and rotation means comprise a carriage group for each panel.

16. The movable panel system of claim 1, wherein the least one panel is made of glass.

17. The movable panel system of claim 1, wherein, in the end configuration, the retaining and lifting device engages the base so that both wheels are disengaged from the respective rail allowing the movement about the vertical axis of the at least one panel.

18. The movable panel system of claim 10, wherein the retaining and lifting member comprises an inclined plane.
